(19) United States
(12) Patent Application Publication
(10) Pub. No.: US 2011/0178960 A1
(43) Pub. Date: Jul. 21, 2011

(54) SMART QUEUING METHOD AND SYSTEM

(76) Inventors: Tom Dever, Austin, TX (US); Ryan VanAlstine, Hutto, TX (US); Derek Dicker, El Dorado Hills, CA (US)

(21) Appl. No.: 12/986,052

(22) Filed: Jan. 6, 2011

Related U.S. Application Data
(60) Provisional application No. 61/296,124, filed on Jan. 19, 2010.

(51) Int. Cl. G06Q 90/00

(52) U.S. Cl. 705/500

(57) ABSTRACT

The present disclosure presents a novel approach to customer queuing, customer relationship tracking, and/or directed advertising. Customers may be notified by text message or by cell phone call when they reach the head of the line, and they may respond to the automated notification. The venue collects key contact information from its patrons that can be used to connect with them at a later time. The present disclosure eliminates reliance on expensive pager systems, allows customers to roam more freely, and gives hosts and hostesses more freedom in acquiring and disposing of customers. The system is also configurable to the venue's attributes some examples of which include smoking/non-smoking, inside/outside, number of tables, and wait time algorithms for customer wait time prediction.

### CROSS-REFERENCE TO RELATED APPLICATIONS

This application claims priority to U.S. Provisional Application Ser. No. 61/296,124, filed Jan. 19, 2010, which is hereby incorporated by reference for all purposes.

### FIELD

This disclosure relates in general to the field of queue management. Particularly, the disclosure relates to cost-effective methods of managing customer queues in various types of venue.

### DESCRIPTION OF THE RELATED ART

Managing queues of people has long been a challenge for several industries. In the restaurant industry, for example, present-day solutions include the use of hand-written lists of names that are managed manually, or (where affordable and appropriate) the use of relatively simplistic pager systems. In each of these cases, customers are required to wait in close proximity to the entrance of the restaurant, often forced to remain in tight and uncomfortable quarters while they wait to hear their name called by a host or hostess. Pagers may allow customers to roam slightly farther than systems using hand-written lists, but customers are still confined within the effective radius of the pager system. This may lead to decreased revenues, as some customers refuse to wait and simply go elsewhere.

For the restaurateur, the cost of deploying a pager system can be cost-prohibitive—both from the perspective of the initial cash outlay as well as the operational cost of maintaining the system. Pagers can easily disappear or be damaged, and customers have little incentive to treat them delicately and avoid harming them.

### SUMMARY

Therefore, a need has arisen for an improved queue management system. The system of the present disclosure may alleviate several of the problems with known queue management systems. For example, according to the present disclosure, reliance on expensive and easily damaged pagers may be completely eliminated.

The present disclosure enables customers to simply provide their name and some unique mobile identification information, e.g. cell phone number, email address, or instant message name, to a hostess and to wait to receive notification (of a free table)—which may arrive in the form of either a text message or an automated call to his/her cell phone or other connected device. The present disclosure is not limited to embodiments using the customer's cell phone. Any sort of device capable of receiving a message could be used in place of a cell phone. An embodiment involving a customer's cell phone is provided merely for illustrative purposes, to point out the features of the present disclosure.

In addition to the value of freeing a waiting customer to travel away from the restaurant (within, e.g., 5 minutes) while he/she waits for a table, the restaurant receives the value of capturing the name and phone number of each customer who chooses to provide it. The present disclosure could also be applied to take-out orders, allowing customers to come in at the optimal time to pick up their food and eliminating waiting and loitering.

According to the present disclosure, a hostess may be able to walk around the venue with a handheld device capable of managing the queue. In one embodiment, the hostess's handheld device (smart queuing mobile device) may be a mobile computing device or similar, which may connect to the venue's wireless network connection or a direct connection to a cellular network. The mobile computing device could be any type of suitable mobile device; for example, a mobile phone, a smartphone, a PDA, an MDA, a portable computer, or any other suitable mobile device. The mobile computing device could be, but does not necessarily have to be, a general purpose computing device as shown in FIG. 1. Freeing the hostess from a station at the entrance of the venue may provide further benefits.

The present disclosure also allows the venue to configure the queuing system to match it specifically to the venue's attributes (e.g., number of tables of a certain size, typical wait times per size of parties, etc.).

These and other advantages of the disclosed subject matter, as well as additional novel features, will be apparent from the description provided herein. The intent of this summary is not to be a comprehensive description of the subject matter of the present disclosure, but rather to provide a short overview of some of the subject matter's functionality. Other systems, methods, features and advantages here provided will become apparent to one with skill in the art upon examination of the following FIGURES and detailed description.

### BRIEF DESCRIPTIONS OF THE DRAWINGS

The features, nature, and advantages of the disclosed subject matter may become more apparent from the detailed description set forth below when taken in conjunction with the drawings, in which like reference numerals indicate like features and wherein:

FIG. 1 shows a computer system and related peripherals that may operate with the interactive metro guide of the present embodiment;

FIG. 2 shows a flowchart of an embodiment of a top level process for customer acquisition, disposition, and double opt-in;

FIG. 3 shows a detailed flowchart of an embodiment of a process for customer acquisition;

FIG. 4 shows a detailed flowchart of an embodiment of a process for customer disposition;

FIG. 5 shows a flowchart of an embodiment of a process for customer acquisition and disposition when no queue is present; and

FIG. 6 shows an embodiment of a site hardware setup.

### DETAILED DESCRIPTION OF THE ILLUSTRATIVE EMBODIMENTS

The following description is not to be taken in a limiting sense, but is made for the purpose of describing the general principles of the present disclosure. Particularly, the present disclosure is described in terms of the restaurant industry; however, one of ordinary skill in the art will recognize the multitude of industries in which the presently disclosed system could be put to use. Exemplary embodiments of the present disclosure are illustrated in the drawings, like numbers being used to refer to like and corresponding parts of the various drawings.

Because the system of the present disclosure eliminates the cost of a paging device and instead leverages a device which consumers already possess—a cell phone—it may enable a drastic reduction in the cost of deployment for the restaurateur. The space formerly reserved for waiting customers may be repurposed and exploited in a more valuable way (e.g., a restaurant could fit more tables into the same room). Incrementally, reports can be generated that lend valuable insight for the restaurateur: arrival rate of customers over any given window of time (e.g. when is the heaviest period of customer traffic, how does it look vs. historicals), how many customers are repeat customers, etc.

The present disclosure relies on hardware that most customers already own, instead of requiring expensive pagers. A further advantage of this aspect of the present disclosure is that customers may have more of an incentive to avoid loss and damage to the paging device.

In addition to simplifying queuing, the present disclosure may include a customer loyalty or “frequent patron or diner”-type program. This aspect of the present disclosure provides an incentive for customers to participate in the queuing solution of the present disclosure; additionally, the customer loyalty program may be implemented when there is not a queue. Customers may choose to opt-in to receive special incentives based on various metrics of loyalty (e.g. number of visits to the establishment, amount of money spent at the establishment, etc.), causing a transformation in the state of a customer loyalty database. A restaurant owner may be able to access reports generated from the customer loyalty program that would help in targeting his advertising (e.g. different “levels” of customer loyalty could be established such that those customers who spend more money, or visit more often, receive more valuable incentives than customers who spend less, or visit less often). By interfacing the customer loyalty program with various systems used in the establishment (e.g. order entry systems, payment systems), advertising and incentives could be more targeted. As an example, a restaurant owner could learn that his highest monthly ticket-generating customer consistently orders a specific entree with each visit. The customer loyalty program could offer suggestions to the restaurant owner regarding how best to incentivize this particular customer (e.g. offering his favorite entree to him the next time he visits the establishment). Tracking of the loyalty program could also be handled via an application on the customer's portable device, transforming the memory state of that device.

In addition to simplifying queuing, the present disclosure may interface with customer loyalty or “frequent diner”-type programs. This aspect of the present disclosure provides an incentive for customers to participate in the queuing solution of the present disclosure. Once a customer has opted in to the system, targeted advertising is further made possible.

The ideas of the present disclosure could also be incorporated into many other situations. One example is a theme park, where lines for popular rides could be eliminated, allowing customers to spend their time and money on other rides or attractions while they wait to be notified. Another example is a waiting line for children to sit on Santa's lap during the Christmas season at, e.g., a shopping mall. Un-tethering shoppers from the physical line may allow them to continue shopping and spending, as well as eliminating crowding. Further examples include museums, monuments, picture booths in malls, zoos, jewelry repair shops, any kind of shop that repairs items while a customer waits, pharmacies, hair salons, nail salons, massage parlors, banks, tailors, car repair shops, oil change shops, tire change shops, framing shops, airline standby/upgrade lists, and any type of venue with “while you wait” type services.

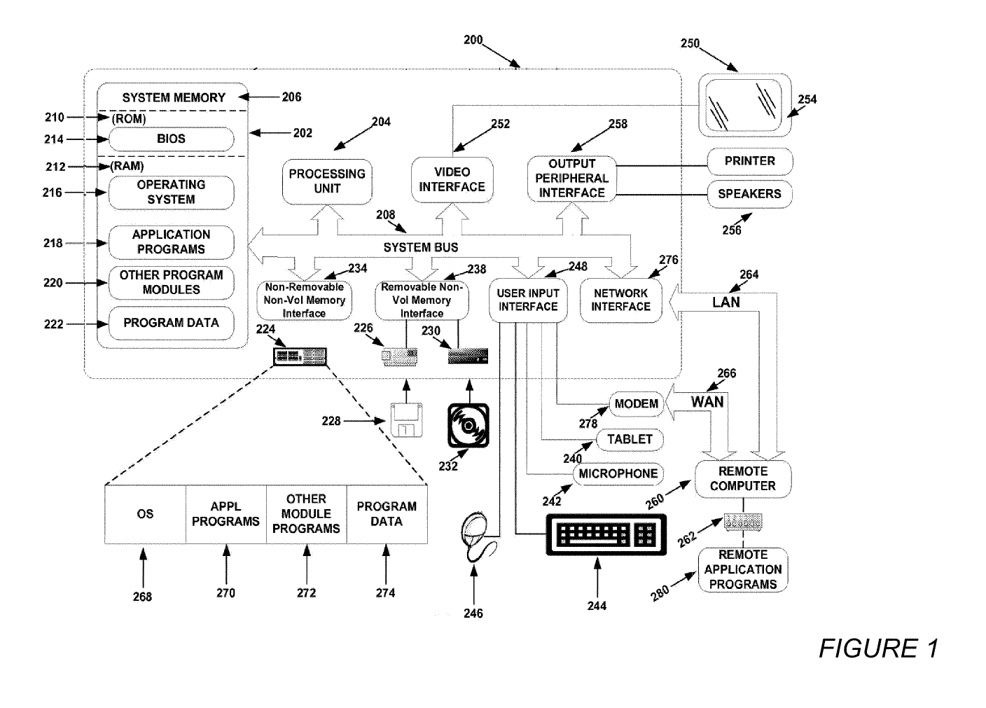

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

For example, in the present embodiment, the computer system 200 may comprise the source machine from which data is being migrated, and the remote computing system 260 may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

A computing device such as the one shown in FIG. 1 may be used to implement various parts of the system of the present disclosure. For example, the backend server housing the customer loyalty database may be implemented on such a general purpose computing device. Further, within the restaurant, the smart queuing mobile device may be in accordance with the general purpose computer shown in FIG. 1.

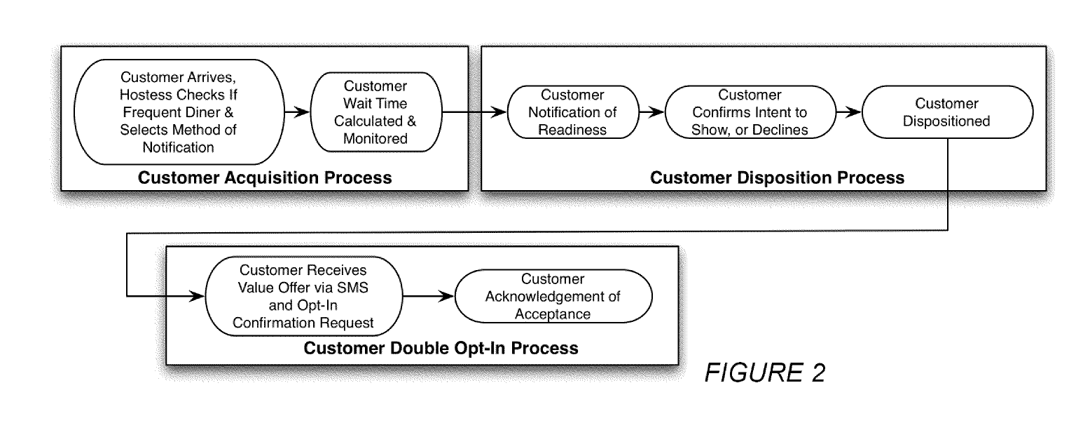

FIG. 2 shows a high-level overview of an embodiment of the customer acquisition and disposition process. According to this embodiment, when a customer arrives at a venue, a hostess first checks to see if he is a frequent diner. She also selects his preferred method of notification. After the hostess enters the customer into the system, his wait time may be calculated, and then monitored in a variety of ways.

When the customer's table is ready, he receives via his cell phone an indication to that effect (e.g., a text message, voice call, email, or instant message). The customer may then respond, indicating whether or not he intends to return to the venue. In some embodiments, the customer may also have the option of responding that he would like to postpone his return.

FIG. 2 also highlights another feature of the present disclosure, the double opt-in process. At a later time, the customer may receive targeted advertising via his preferred contact method. He may have the chance to opt-in to further advertising and promotions, or decline to be contacted again in this way. His response may cause a transformation in the state of the customer loyalty database.

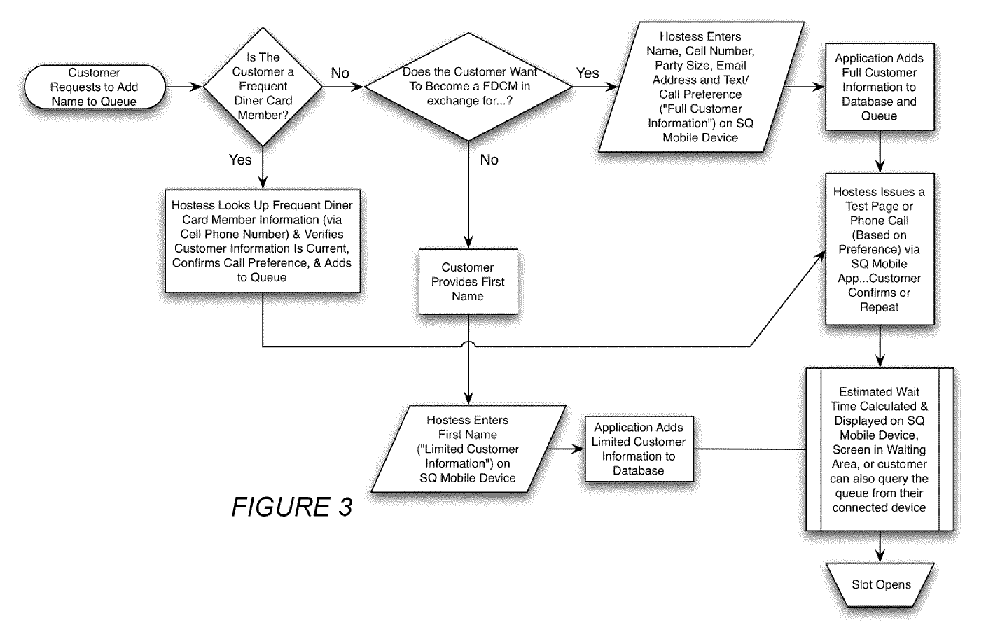

FIG. 3 shows a flowchart of an embodiment of a process for customer acquisition in the presence of a queue.

When the customer requests to be added to the queue, the hostess first checks to see if he is a Frequent Diner Card Member (in order to use the cell phone notification system). If he is already a Member, the hostess may verify his information and then add him to the queue. If he is not a Member (but wishes to become one), then hostess may enter his name, cell phone number, party size, email address, and notification-method preference into the smart queuing mobile device. The customer may then be added to the queue. After the customer's information is in the queue, the hostess may issue a test notification to ensure that the information is correct and that the customer will receive the real notification when his table is ready. The customer may confirm this test notification, or the system may issue another test. The customer may also use the test notification to track his position in the queue.

If, on the other hand, the customer does not wish to become a Member, the hostess may add limited information (first name and party size, for example) to the queue.

Once the customer is in the queue, approximate wait time may be calculated and displayed on the smart queuing mobile device and/or a monitor in the waiting area and/or queried by the customer directly from their connected device.

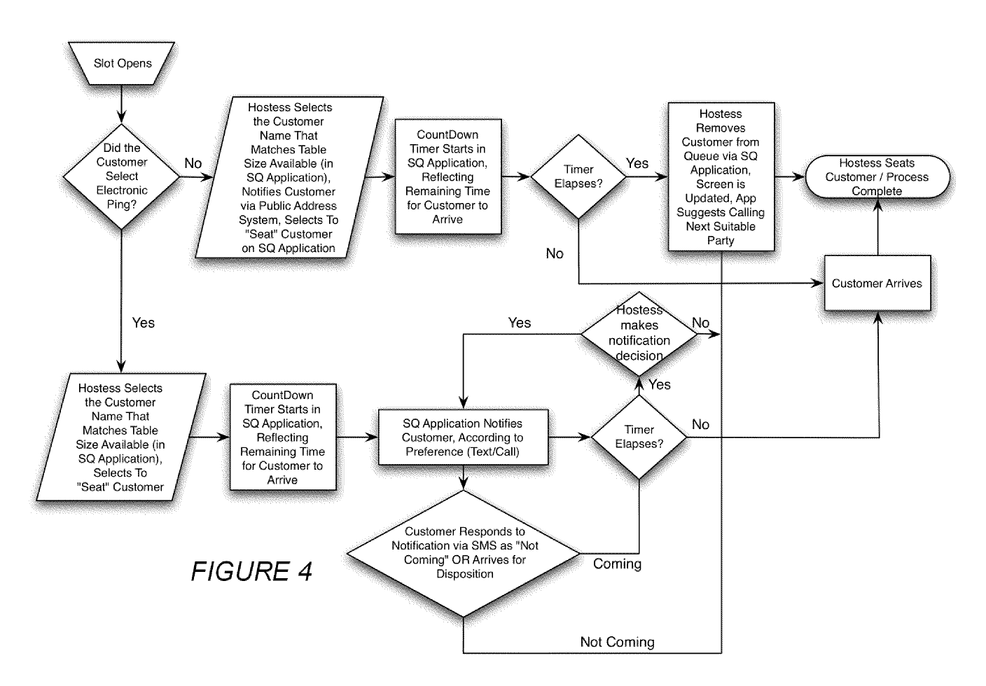

FIG. 4 shows a flowchart of an embodiment of a process for customer disposition, which may follow the processes shown in FIG. 3, picking up at the point at which a table becomes available.

If the customer has chosen electronic notification, the hostess chooses his name on the smart queuing mobile device. The system then sends a notification (text or voice call) and starts a countdown timer. If the timer elapses before the customer responds (or if the customer responds that he is not coming), the hostess may remove him from the queue and call the next suitable party.

If the customer shows up within the time limit without responding, he is simply seated. If he responds that he is coming and the time limit expires, the hostess may make a call whether to remove the customer from the list or send another notification.

If, on the other hand, the customer did not choose to participate in the electronic notifications, the hostess may simply notify him via a public address system when his table becomes available. Again, a countdown timer may be set. If it elapses before the customer appears, he is removed from the list, and the hostess may proceed to the next suitable party. If it does not elapse before he appears, he may be seated.

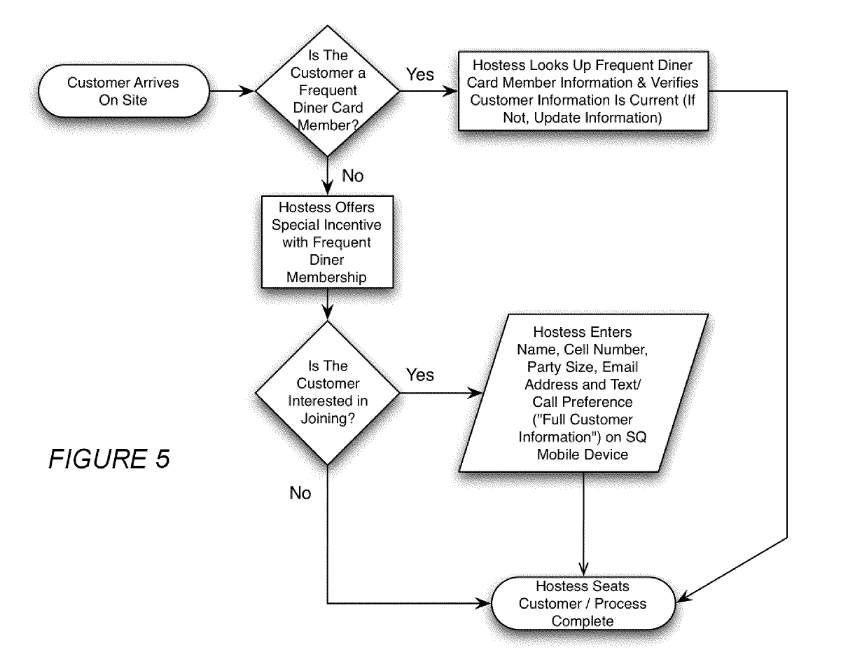

FIG. 5 shows a flowchart of an embodiment of a process for customer acquisition and disposition when no queue of other customers is present. The process is shortened and simplified if no one is waiting in the queue ahead of the customer.

If the customer is a Frequent Diner Card Member, the hostess may verify his information and simply seat him. If he is not a Member, the hostess may offer him some promotional deal to become one. If he accepts, his information is entered into the system, and he is seated. If he declines, he is simply seated.

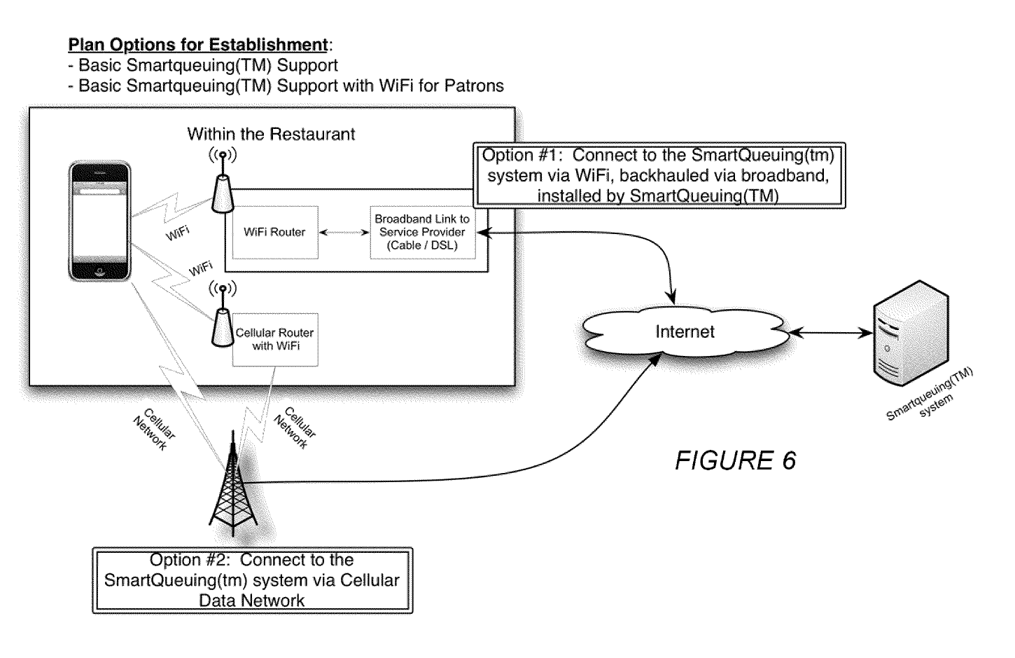

FIG. 6 shows different ways in which the hardware of the present disclosure may be set up. Most of the information used by the system is kept locally at the restaurant. All information about the current queue state and anything else needed to manage the queue is kept locally. However, the customer database and marketing/double opt-in information may be kept on a remote server, accessible over the Internet.

Within the restaurant, the smart queuing mobile device connects to the Internet via a wireless router or cellular connection. That router may connect to the Internet either via the cellular network or via a wired broadband connection. The WiFi network may optionally be shared with customers inside the restaurant, on an hourly basis paid or unpaid if desired. The WiFi network may also optionally be scheduled to function only at certain times during the day.

The system of the present disclosure may also be used to provide value to venue owners in other ways. For example, customer loyalty may be encouraged by giving special offers to frequent diners. Information about eating habits may be collected, e.g., on a per-chain basis and used for targeted advertising.

Customers may be allowed to reserve their places in the queue on the Internet or by calling in. Approximate wait times may be made available to customers in a variety of ways: for example, via a web site, a cell phone app, Twitter, a call-in phone number, or a video display in the waiting area.

The foregoing description of embodiments is provided to enable a person skilled in the art to make and use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein. What is claimed is all of the subject matter described in this disclosure.

What is claimed is:

1. All of the disclosed subject matter.
